(19) United States
(12) Patent Application Publication
(10) Pub. No.: US 2026/0046740 A1
(43) Pub. Date: Feb. 12, 2026

(54) METHODS, ARCHITECTURES, APPARATUSES AND SYSTEMS FOR RELAY RESELECTION FOR MULTIHOP UE-TO-NETWORK RELAY CONNECTION

(71) Applicant: InterDigital Patent Holdings, Inc., Wilmington, DE (US)

(72) Inventors: Jung Je Son, Warrington, PA (US); Taimoor Abbas, Sainte-Julie (CA); Samir Ferdi, Kirkland (CA)

(21) Appl. No.: 18/798,197

(22) Filed: Aug. 8, 2024

(51) Int. Cl. H04W 40/22; H04L 45/00; H04W 40/36

(52) U.S. Cl. CPC H04W 40/22; H04L 45/20; H04W 40/36

(57) ABSTRACT

Procedures, methods, architectures, apparatuses, systems, devices, and computer program products for relay reselection in a wireless communication network. A remote user equipment (UE) may establish a multihop connection to a network via one or more intermediate relays and a UE-to-network (U2N) relay. When relay reselection is triggered, an intermediate relay or the U2N relay may check whether there is an existing connection (e.g., a mapping for traffic forwarding exists) for the remote UE. For example, the intermediate relay may decide to reuse the existing connection to the U2N relay for a new path to the remote UE. An IP address of the remote UE may be signaled to other intermediate relays along the new path.

### BACKGROUND

The present application is related to the fields of communications, software and encoding, including, for example, to methods, architectures, apparatuses, systems directed to 5G Proximity Services (ProSe) and multi-hop connections using user equipment-to-network (UE-to-Network or U2N) relays including relay reselection procedures.

A ProSe UE-to-Network relay entity provides the functionality to support connectivity to the network for remote UEs. Multi-hop for UE-to-Network Relays can enable a remote UE to discover and communicate with a UE-to-Network Relay via one or more UE-to-UE relays. It would be desirable to provide relay reselection procedures which provide session continuity for a service provided by to a Remote UE in a multi-hop environment.

### BRIEF SUMMARY

Briefly stated, in one embodiment a UE-to-Network (U2N) (e.g., a wireless transmit/receive unit (WTRU) serving as a U2N relay) may establish a first end-to-end connection with a remote UE (e.g., WTRU) via a first multihop path over a first set of intermediate (IM) relays (e.g., WTRUs serving as IM relays). For example, an internet protocol (IP) address of the remote UE may be assigned for traffic carried over the first end-to-end connection. The U2N relay may receive (e.g., from the child IM relay of the second set of IM relays) a request message including (e.g., path) information indicating a second end-to-end connection with the remote UE via a second multihop path (e.g., different than the first multihop path) over a second set (e.g., different than the first set) of IM relays. For example, sending of the request message may be triggered due to link failure or link degradation. The U2N relay may determine to reuse an existing PC5 connection with a child IM relay of the second set of IM relays. The U2N relay may send (e.g., to the child IM relay of the second set of IM relays) an accept message, responsive to the request message, including information indicating the second end-to-end connection is accepted. For example, the accept message may include (e.g., path) information indicating the second multihop path including the second set of IM relays. The U2N relay may send (e.g., to the child IM relay of the second set of IM relays) information indicating an IP address of the remote UE is associated with the second multihop path. The U2N relay may communicate (e.g., send and/or receive) traffic associated with the IP address of the remote UE via the PC5 connection with the child IM relay of the second set of IM relays. For example., the traffic may be mapped at the U2N relay so that the traffic is sent over the PC5 connection along the second multihop path to (e.g., towards) the remote UE.

In one embodiment, an IM relay (e.g., WTRU) may receive a first request message including information indicating an end-to-end connection with a remote UE (e.g., WTRU) and a U2N relay (e.g., a WTRU serving as a U2N relay) via a multihop path over a set of IM relays (e.g., including the IM relay itself). For example, the first request message may include (e.g., path) information indicating the multihop path over the set of IM relays. For example, sending of the request message may be triggered due to link failure or link degradation. The IM relay 402 may send, via an existing PC5 connection with the U2N relay, a second request message including information in dicating the end-to-end connection with the remote UE via the multihop path over the set of IM relays. The IM relay may receive, via the PC5 connection with the U2N relay, a first accept message, responsive to the second request message, including information indicating the second request message is accepted. For example, the first accept message may include (e.g., path) information indicating the multihop path over the set of IM relays. The IM relay may send a second accept message, responsive to the first request message, including information indicating the first request message is accepted. For example, the second accept message may include (e.g., path) information indicating the multihop path over the set of IM relays. The IM relay may receive information indicating that an IP address of the remote UE is associated with the multihop path. The IM relay may communicate traffic associated with the IP address to the remote UE via the PC5 connection with the U2N relay.

In one embodiment, an IM relay (e.g., WTRU serving as an IM relay) may establish a first end-to-end connection between a remote UE (e.g., WTRU) and a U2N relay (e.g., another WTRU serving as a U2N relay) via a first multihop path over a first set of IM relays. The IM relay may receive a request message including information indicating a second end-to-end connection between the remote UE and the U2N relay via a second multihop path over a second set of IM relays. For example, the request message may include (e.g., path) information indicating the second multihop path including the second set of IM relays. For example, sending of the request message may be triggered due to link failure or link degradation. The IM relay may determine to reuse an existing PC5 connection with a parent relay associated with the second multihop path. The IM relay may send an accept message, responsive to the request message, including information indicating the second end-to-end connection is accepted. For example, the accept message may include (e.g., path) information indicating the second multihop path including the second set of IM relays. The IM relay may send (e.g., to a child IM relay of the second set of IM relays) information indicating an IP address of the remote UE is associated with the second multihop path. The IM relay may communicate traffic associated with the IP address of the remote UE via the PC5 connection with the parent relay associated with the second multihop path.

In one embodiment, a U2N relay device (e.g., a WTRU serving as a U2N relay) may set up (e.g., establish) an end-to-end connection with a remote UE via a set of IM relays. The U2N relay device may receive a direct connection request (DCR) message, or link modification request (LMR) message, from another IM relay which requests an end-to-end connection setup between the remote UE and the U2N relay via a new path which different from a stored context (e.g., associated with the established end-to-end connection) in the U2N relay. The U2N relay may determine to reuse an existing connection (e.g., to the requesting IM relay) for the remote UE. The U2N relay send a direct connection accept (DCA) message or link modification accept (LMA) message to the other IM relay for connection setup between the remote UE and the U2N relay via the new path. The U2N relay may update the connection for the remote UE to be mapped to the requested connection based on the new path. The U2N relay may send information (e.g., signaling) informing the IP address of the remote UE to the other IM Relay in the (e.g., new) path.

In one embodiment, an IM relay device (e.g., a WTRU) may set up and manage a PC5 connection with its parent relay and a PC5 connection with its child relay for serving a remote UE. The IM relay may receive a DCR message or LMR message from another IM relay which requests end-to-end connection set up between the remote UE and a U2N relay device via a new path including the other IM relay, the IM relay itself, and a parent relay for serving the remote UE. The IM relay may detect an existing connection with the parent relay for serving the end-to-end connection between the remote UE and the U2N relay. The IM relay may decide to reuse the existing connection with its parent relay for the remote UE. The IM relay may send a DCA message or LMA message to the other IM relay for the connection set up between the remote UE and the U2N relay via the path including the other IM relay, the IM relay itself, and its parent relay. The IM relay may update the connection with its parent relay for the remote UE to be mapped to the connection with the other IM relay. The IM relay may send information (e.g., signaling) informing the IP address of the remote UE to the other IM relay.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings. In the drawings:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram illustrating an example architecture model using a ProSe UE-to-Network relay;

FIG. 3 is a procedural diagram illustrating an example procedure using a ProSe UE-to-Network relay;

FIG. 4 is a system diagram illustrating an example scenario for relay reselection of multihop UE-to-Network relays;

FIG. 5 is a communications diagram illustrating an example of relay reselection with session continuity by intermediate (IM) relays;

FIG. 6 is a communications diagram illustrating an example of relay reselection with session continuity by a U2N relay;

FIG. 7 is a flow diagram illustrating an example procedure which may be implemented by a U2N relay;

FIG. 8 is a flow diagram illustrating an example procedure which may be implemented by an IM relay; and

FIG. 9 is a flow diagram illustrating an example procedure which may be implemented by an IM relay.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

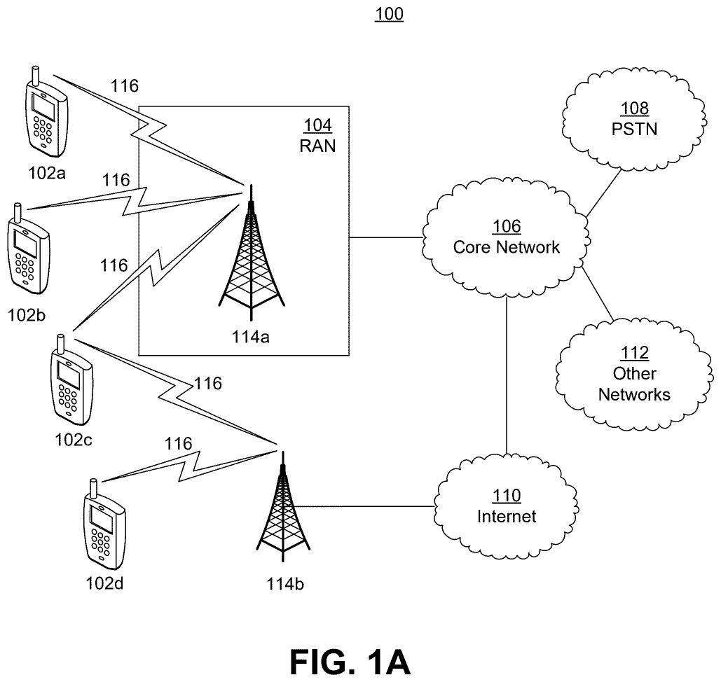

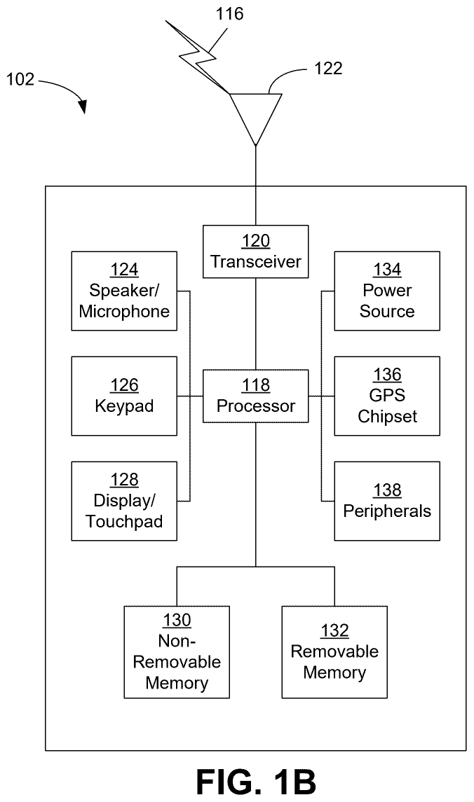

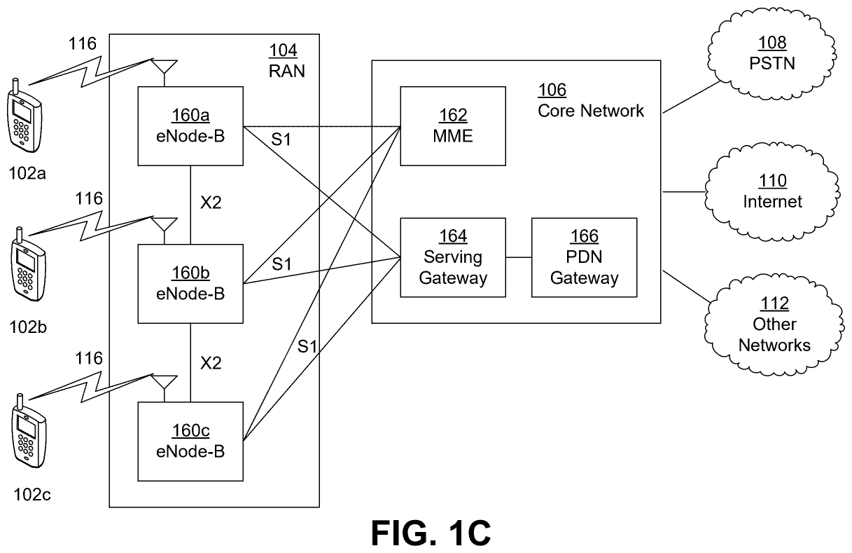

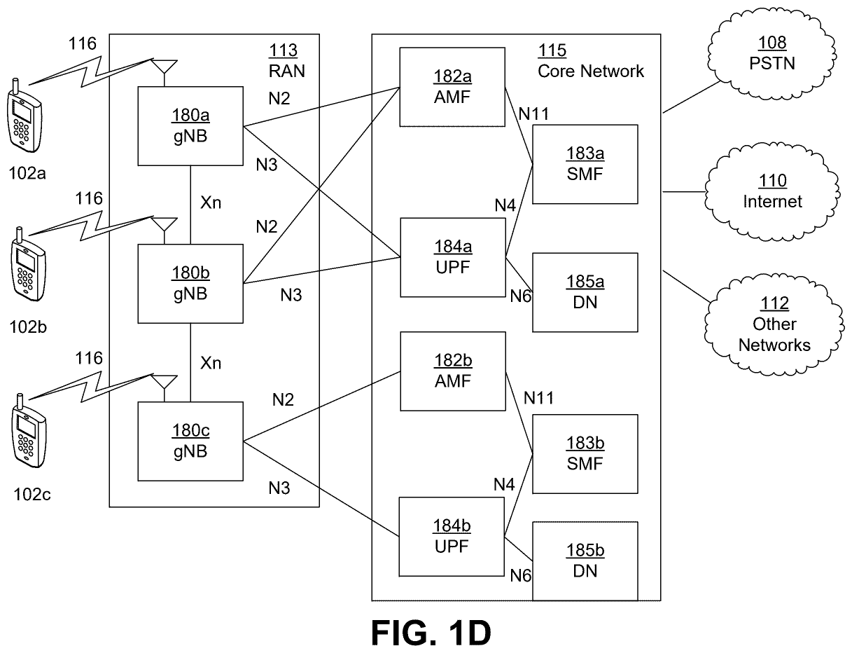

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Abbreviations and Acronyms

The following abbreviations and acronyms are used herein:
DCR/DCA Direct Connection Request/Accept
LMR/LMA Link Modification Request/Accept
IM Relay Intermediate Relay
RSC Relay Service Code
Remote UE UE communicates with a data network via a U2N relay
UE User Equipment
U2N Relay UE-to-Network Relay
U2U Relay UE-to-UE Relay

### Introduction

As used herein, a remote UE may refer to a UE (or WTRU) that communicates with a data network via a U2N relay (e.g., UE or WTRU).

As used herein, an IM relay (e.g., UE or WTRU) may refer to a relay which relays traffic between one or more remote UEs and a U2N relay.

As used herein, U2N relay UE (or WTRU) and U2N relay may be used interchangeably.

As used herein, IM relay UE (or WTRU) and IM relay may be used interchangeably.

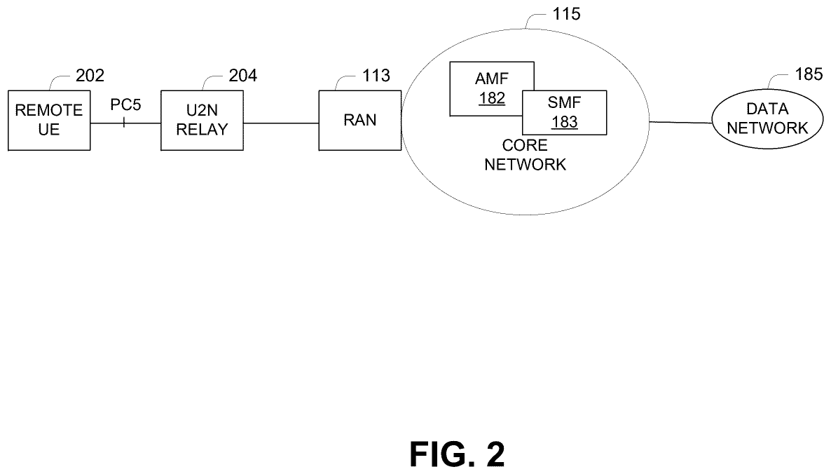

FIG. 2 is a system diagram illustrating an example architecture model using a ProSe UE-to-Network relay 204. A ProSe UE-to-Network relay entity may provide the functionality to support connectivity to the network for a remote UE 202. If the remote UE 202 is out of NR coverage provided by the RAN 113 and cannot communicate with the core network 115 directly, or in NR coverage but prefers to use PC5 for communication, the remote UE 202 may discover and select a U2N relay 204 (e.g., a U2N relay UE). Then, the remote UE 202 may establish a PC5 session with UE-to-Network Relay 204 and the UE-to-Network Relay 204 may establish a PDU session (or PDN connection in EPC) for the remote UE 202. After IP address/prefix allocation, traffic between the remote UE 202 and the network may be relayed by the UE-to-Network Relay 204.

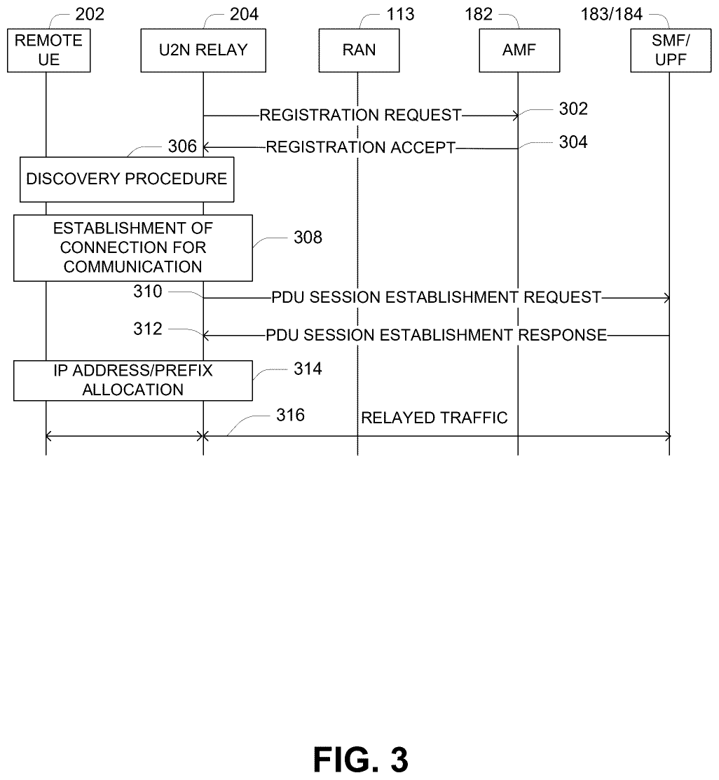

FIG. 3 is a communications diagram illustrating an example of using a ProSe UE-to-Network relay. As shown in FIG. 3, a U2N relay 204 may register with the network. For example, the U2N relay 204 may send a registration request message to an AMF 182 at 302. At 304, the AMF 182 (e.g., in response to the registration request message) may send a registration accept message to the U2N relay 204. At 306, the remote UE 202 may discover the U2N relay 204 via the discovery procedure at 306, or vice versa. At 308, a connection for communication (e.g., a PC5 session) may be established between the remote UE 202 and the U2N relay 204. At 310, the U2N relay 204 may send a PDU session establishment request message to a SMF 183 and/or UPF 184. At 312, the SMF 183 and/or UPF 184 may (e.g., in response to the PDU session establishment request message) send a PDU session establishment response message to the U2N relay 204. IP address/prefix allocation may be performed at 314. At 316, the U2N relay 204 may communicate (e.g., relay) traffic between the remote UE 202 and the network (e.g., UPF 184).

For 5G ProSe UE-to-Network Relay discovery, both Model A and Model B discovery are supported. Model A uses a single discovery protocol message (e.g., Announcement). Model B uses two discovery protocol messages (e.g., Solicitation and Response).

In certain embodiments, for Relay Discovery Additional Information, (e.g., only) Model A discovery is used.

For 5G ProSE UE-to-NW relays, layer-2 (L2) link procedures over the PC5 reference point for unicast mode 5G ProSe Direct Communication may (e.g., should) be performed between the remote UE 202 and U2N Relay UE. The layer-2 link procedures may include any of L2 link establishment over PC5, Link ID update for a unicast link, L2 link release over the PC5 reference point, L2 link modification for a unicast link, and/or L2 link maintenance over the PC5 reference point (e.g., keep alive procedure).

And after being connected to a 5G ProSe UE-to-Network Relay, a 5G ProSe Remote UE may perform (e.g., keep performing) the measurement of the signal strength of the PC5 unicast link with the 5G ProSe UE-to-Network Relay for relay reselection. For relay reselection procedures, the 5G ProSe UE-to-Network Relay discovery procedures may be used to discover available 5G ProSe UE-to-Network Relays for 5G ProSe UE-to-Network Relay reselection.

Proposals in 3GPP to study potential enhancements to support multi-hop for U2N relay in Rel-19 are being discussed.

Multi-hop for a U2N Relays enable a Remote UE to discover and communicate with a U2N Relay via one or more U2U relays. For a multi-hop U2N relay, standalone discovery & link setup/management is supported and both Model A and Model B are supported. The 5G ProSe Direct Discovery message is to be extended with an indication that multi-hop relay is supported, along with the hop count and the maximum number of hops.

For a multi-hop U2N Relay, the Remote UE may select both the UE-to-Network Relay and the path to reach the UE-to-Network Relay. To perform link management, the Direct Communication Request (DCR) message may be sent (e.g., unicast) between relays according to the path information included in the message. The path information may be provided as a (e.g., ordered) list of User Info IDs of Relays in the selected path. The Remote UE sends the selected path information towards the UE-to-Network Relay for communication setup. For example, the relay path may be selected based on any of the PC5 signal strength, number of hops between the Remote UE and the UE-to-Network Relay UE, per-hop and/or cumulative QoS information.

In certain representative embodiments, session continuity may be provided during relay reselection for multihop U2N relays. For example, during relay reselection procedures, it may be important to provide session continuity for any service(s) provided to a Remote UE via U2N Relay and IM Relays.

In certain representative embodiments, when a layer-3 (L3) U2N Relay changes, the Remote UE may need to get a (e.g., new) IP address from the U2N relay, and session continuity may (e.g., shall) be supported by the application layer at the Remote UE.

In certain representative embodiments, when relay reselection happens without a change of U2N relay, session continuity for the connection between the U2N relay and the Remote UE via IM relays may (e.g., shall) be managed by the U2N relay, IM relays, and/or the Remote UE.

There may be two different use cases may be considered for relay reselection.

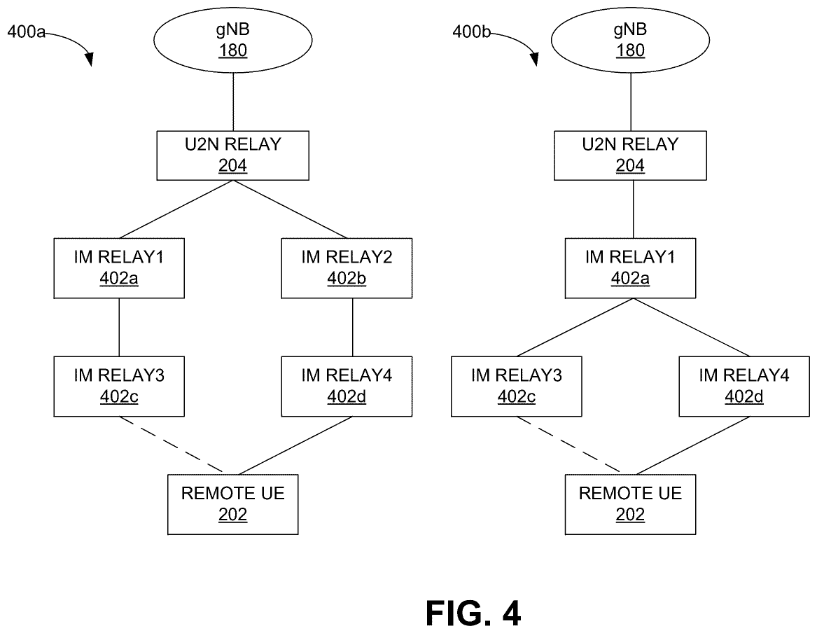

FIG. 4 is a system diagram illustrating an example scenario for relay reselection of multihop UE-to-Network relays. In FIG. 4, a U2N relay 204 may provide connectivity to a gNB 180. A plurality of IM relays, such as IM relay1 402a, IM relay2 402b, IM relay3 402c and IM relay4 402d, may be present to provide a plurality of multihop pathways between a Remote UE 202 and the U2N relay 204.

As shown in FIG. 4, the Remote UE 202 may be connected to the U2N relay 204 via an IM Relay3 and IM Relay1. The Remote UE 202 may check the quality of links to the U2N relay 204 via the selected path. When a quality of service of the connection becomes less than a service requirement (e.g., because of bad signal quality between the Remote UE 202 and IM Relay3 402c, or because of overall end-to-end delay is greater than the service requirement, etc), the Remote UE 202 may initiate a relay reselection procedure to another path.

In 400a of FIG. 4, a new path to the U2N relay 204 may be discovered that involves IM Relay4 402d and IM Relay2 402b. In this scenario, the U2N relay 204 and the Remote UE 202 may need to become aware that new IM relays are selected. In 400b of FIG. 4, a new path to the U2N relay 204 may be discovered that involves the IM Relay4 402d and the IM Relay1 402a. In this scenario, the U2N relay 204 may not need to be aware of the path change between the IM Relay1 402a and Remote UE 202 via a change from using the IM Relay3 402c to using the IM Relay4 402d.

As seen in FIG. 4, different entities (e.g., U2N Relay 204, Remote UE 202, or IM Relays) may be involved for different scenarios and the relay reselections.

In certain representative embodiments, it may be desirable to provide session continuity while performing relay reselection procedure in any of the various scenarios.

### Overview

In certain representative embodiments, for multihop U2N relay discovery, a multi-hop indication, such as RSC supporting multihop U2N relay service, hop count, and path information (e.g., a list of IM relays) may be included.

In certain representative embodiments, for end to end connection setup, the path information (e.g., as identified by the discovery procedure) may be included in a DCR message and DCA message.

In certain representative embodiments, session continuity may be supported by IM relays during relay reselection for multihop U2N relays.

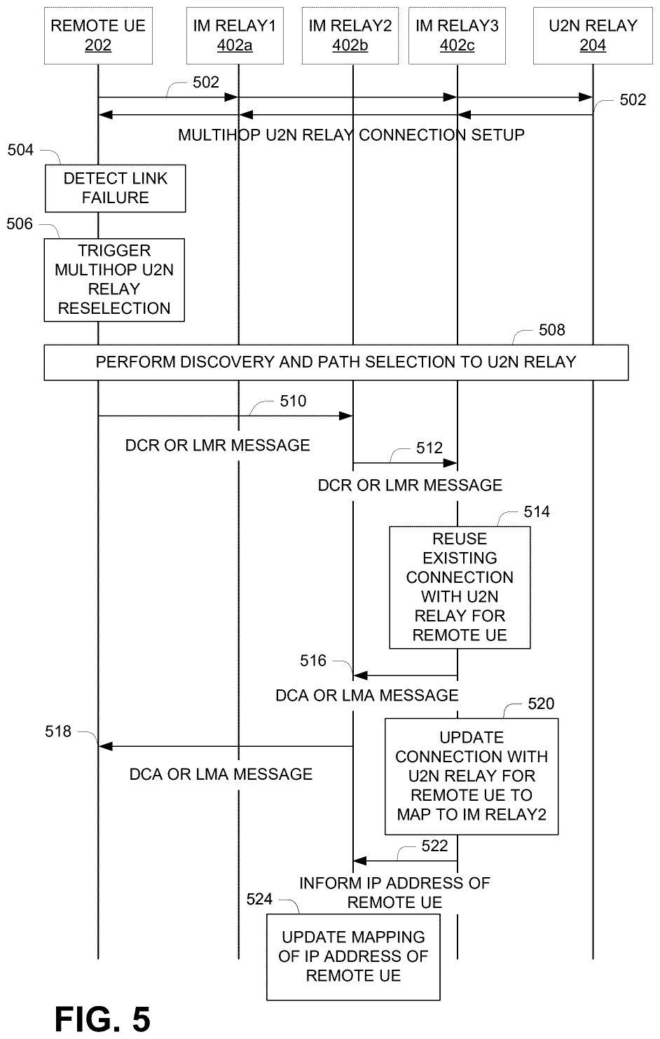

FIG. 5 is a communications diagram illustrating an example of relay reselection with session continuity (e.g., supported) by IM relays.

At 502, a Remote UE 202 may setup an end-to-end connection with a U2N Relay UE 204 via an IM Relay1 402a and an IM Relay3 402c. For example, the Remote UE 202, the U2N Relay 204, the IM Relay1 402a, and the IM Relay3 402c may be aware that the Remote UE 202 is connected to the U2N Relay UE 204 via the IM Relay1 402a and the IM Relay3 402c. For traffic forwarding between the Remote UE 202 and the U2N relay UE 204, the Remote UE 202, the U2N Relay UE 204, the IM Relay1 402a, and the IM Relay3 402c may manage the mapping of the traffic to and from the Remote UE 202 (e.g., using an assigned IP address of the Remote UE 202). For example, the Remote UE 202 may use an IP address assigned by the U2N Relay UE 204 (e.g., assigned during end-to-end connection setup).

After the connection setup at 502, the Remote UE 202 may detect a link failure or link quality degradation of the end-to-end link (e.g., with respect to a threshold) to the U2N relay 204 at 504. For example, the Remote UE 202 may monitor the link quality (e.g., with respect to a threshold) of a PC5 link with the IM Relay1 402a and/or the end-to-end link to the U2N Relay 204 at 504. For example, the Remote UE 202 may receive signaling (e.g., a message) indicating link degradation or failure from any of the IM Relays or the U2N Relay 204. The Remote UE 202 may be triggered (e.g., based on link degradation or failure) to perform a multihop U2N relay reselection procedure at 506.

At 508, the Remote UE 202 may perform a discovery procedure, and the Remote UE may select a (e.g., new multihop) path to the U2N relay 204. By way of example in FIG. 5, the new path may be selected as [Remote UE, IM Relay2, IM Relay3, U2N Relay]. In other words, the Remote UE 202 may prefer to use an end-to-end connection with the U2N Relay UE 204 via the IM Relay2 402b and the IM Relay3 402c. In some representative embodiments, the Remote UE 202 may discover and select a new path to the U2N relay 204 by considering any reported alternative paths from the IM Relays without (e.g., further) discovery (e.g., of additional IM Relays).

At 510, the Remote UE 202 may send a DCR message to the IM Relay2 402b to setup an end to end connection via the selected (e.g., new) path to the U2N relay 204. For example, the DCR message may include information indicating user information associated with the Remote UE 202, user information associated with the U2N Relay UE 204, and path information. As examples, the path information may indicate the selected path as [Remote UE, IM Relay2, IM Relay3, U2N Relay] or [IM Relay2, IM Relay3].

At 512, after the IM Relay2 402b has received the DCR message from the Remote UE 202, the IM Relay2 402b may send a DCR (or LMR) message to the IM Relay3 402c. For example, the DCR message may include information indicating user information associated with the Remote UE 202, user information associated with the U2N Relay UE 204, and path information (e.g., as received at 510). For example, there may be an existing connection between the IM Relay2 402b and the IM Relay3 402c, and IM Relay2 may send a LMR message to the IM Relay3 402c. For example, the LMR message may include information indicating user information associated with the Remote UE 202, user information associated with the U2N Relay UE 204, and path information (e.g., as received at 510).

After receiving the DCR or LMR message at 512 from the IM Relay2 402b for setting up the connection between the Remote UE 202 and U2N Relay UE 204 via the IM Relay2 402b and the IM Relay3 402c, IM Relay3 402c may check whether there is a valid mapping for forwarding traffic of the Remote UE 402 to its parent Relay UE (e.g., U2N Relay UE 204 in FIG. 5) at 514. For example, the mapping may include a mapping between packets for the Remote UE 202 to PC5 QoS flows for the connection between the IM Relay3 402c and the U2N Relay 204. As shown in FIG. 5, the IM Relay3 402c may decide to reuse the existing connection with its parent Relay UE (e.g., U2N Relay UE 204) for the Remote UE 202.

At 516, the IM Relay3 402c may send DCA (or LMA) message to the IM Relay2 402b. For example, the DCR (or LMA) message may include information indicating user information associated with the Remote UE 202, user information associated with the U2N Relay 204, and path information (e.g., [IM Relay2, IM Relay3]).

After receiving the DCA or LMA message from the IM Relay3 402c, the IM Relay2 402b may send a DCA (or LMA) message to the Remote UE 202 at 518. For example, the DCA or LMA message may include path information. As examples, the path information may indicate the selected path as [Remote UE, IM Relay2, IM Relay3, U2N Relay] or [IM Relay2, IM Relay3]).

After 514 or 516, the IM Relay3 402c may update the mapping of the connection between the U2N Relay 204 and the Remote UE 202 to include the IM Relay2 402b. For example, the IM Relay3 402c may change path for the Remote UE 202 from [Remote UE, IM Relay1, IM Relay3, U2N Relay] to [Remote UE, IM Relay2, IM Relay3, U2N Relay]. The updated mapping may allow for traffic for the Remote UE 202 to be relayed along the proper path (e.g., to IM Relay2 402b for downlink traffic).

At 522, the IM Relay3 402c may inform the IM Relay2 402b of the IP address of the Remote UE 202 which has been assigned by the U2N Relay 204 for data traffic exchange and which was shared to the IM Relay3 (e.g., during or after 502).

At 524, after receiving the IP address for Remote UE 202, the IM Relay2 402b may update the mapping of the path (e.g., [Remote UE, IM Relay2, IM Relay3, U2N Relay]) between the Remote UE 202 and the U2N Relay 204. For example, the IM Relay2 402b may update the mapping to bind with the IP address of the Remote UE 202 so that when receiving an IP packet including the IP address of Remote UE (e.g., either as a source IP address or a target IP address) the IM Relay2 402b can determine the destination to relay the IP packet to the Remote UE (e.g., when receiving an IP packet including the IP address of Remote UE 202 as a target IP address) or to IM Relay3 402c (e.g., when receiving an IP packet including the IP address of Remote UE 202 as a source IP address).

After receiving the DCA (or LCA) message, the Remote UE 202 may exchange data traffic with the U2N Relay UE 204 via the IM Relay2 402b and the IM Relay3 402c. For example, the data traffic may use the IP address assigned from the U2N Relay 204 and mapped along the updated path according to the IP address.

In some representative embodiments, the relay reselection procedure (e.g., in FIG. 5) may be triggered by any of the IM Relays 402 (e.g., IM Relay1 402a and/or IM Relay3 402c). For example, after the Remote UE 202 and the U2N Relay UE 204 setup the end to end connection (e.g., the multihop path via any of the IM Relay1 402a, IM Relay2 402b, and/or IM Relay3 402c), a link failure or link quality degradation may occur between the IM Relay1 402a and IM Relay2 402b (e.g., due to mobility of the IM Relay2). The IM Relay1 402a may discover new path to the U2N Relay 204 (e.g., [IM Relay1, IM Relay4, IM Relay3]). In this scenario, the IM Relay1 402a may initiate a DCR or LMR message for a new connection setup with the IM Relay4 402d for the end to end connection between the Remote UE 202 and the U2N Relay UE 204. After receiving the DCR or LMR message, the IM Relay4 402d may send a DCR or LMR message to the IM Relay3 402c. After the IM Relay3 402c receives the message from the IM Relay4 402d, the IM Relay3 402c may perform 514 in FIG. 5 to check whether there is a valid mapping for forwarding traffic of Remote UE 202. The IM Relay3 402c may respond to IM Relay4 402d, and the IM Relay4 402d may respond to the IM Relay1 402a with an indication of successful connection setup (e.g., DCA message). Afterwards, the IM Relay3 402c may perform 520 and 522 with the IM Relay4 402d (e.g., instead of IM Relay2 402b as in FIG. 5).

In certain representative embodiments, session continuity may be supported by a U2N Relay during relay reselection for multihop U2N relays.

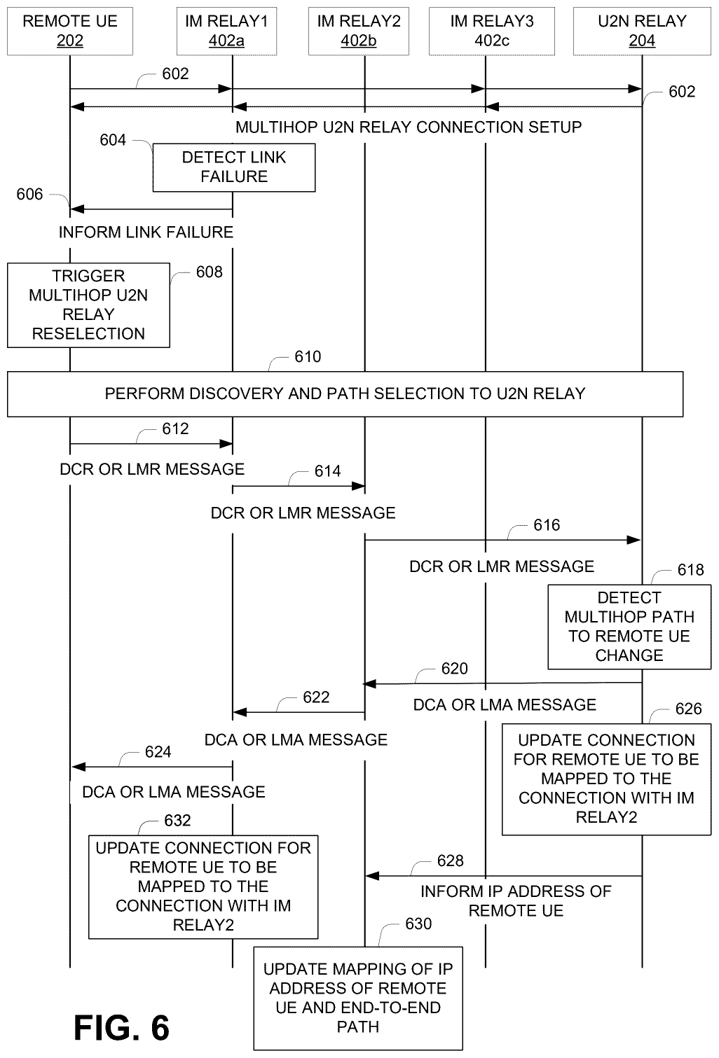

FIG. 6 is a communications diagram illustrating an example of relay reselection with session continuity by a U2N relay.

At 602, a Remote UE may setup end-to-end connection with a U2N Relay UE 204 via an IM Relay1 402a and an IM Relay3 402c. For example, the Remote UE 202, the U2N Relay 204, the IM Relay1 402a, and the IM Relay3 402c may be aware that the Remote UE 202 is connected to the U2N Relay UE 204 via the IM Relay1 402a and the IM Relay3 402c. For traffic forwarding between the Remote UE 202 and the U2N relay UE 204, the Remote UE 202, the U2N Relay UE 204, the IM Relay1 402a, and the IM Relay3 402c may manage the mapping of the path (e.g., with an assigned IP address of the Remote UE 202).

After the connection setup at 602, one of the IM Relays 402 on the path (e.g., the IM Relay1 402a in FIG. 5) may detect a link failure or link quality degradation of the end-to-end link to the U2N relay 204 at 604. For example, the IM Relay1 402a may inform the Remote UE 202 of the link failure at 606. As another example, the Remote UE 202 may monitor the link quality (e.g., with respect to a threshold) of a PC5 link with the IM Relay1 402a and/or the end-to-end link at 604. For example, the Remote UE 202 may receive signaling (e.g., a message) indicating link degradation or failure from any of the IM Relays or the U2N Relay 204 at 606. At 608, the Remote UE 202 may be triggered (e.g., based on link degradation or failure) to perform a multihop U2N relay reselection procedure. As an example, the IM Relay1 402a may detect link failure of the PC5 connection with the IM Relay2 402b and may send signaling (e.g., an indication) of the link failure to the Remote UE 202.

At 610, the Remote UE 202 may perform a discovery procedure, and select a new path to the U2N relay 204. By way of example in FIG. 6, the new path may be selected as [Remote UE, IM Relay1, IM Relay2, U2N Relay]. In other words, the Remote UE 202 may prefer to use an end-to-end connection with the U2N Relay UE 204 via the IM Relay1 402a and the IM Relay2 402b. In some representative embodiments, the Remote UE 202 may discover and select a new path to the U2N relay 204 by considering any reported alternative paths from the IM Relays without (e.g., further) discovery (e.g., of additional IM Relays).

At 612, the Remote UE may sed a LMR or a DCR message to the IM Relay1 402a to request the setup of an end to end connection to the U2N relay via the selected (e.g., new) path. For example, the DCR message may include information indicating user information associated with the Remote UE 202, user information associated with the U2N Relay UE 204, and path information. As examples, the path information may indicate the selected path as [Remote UE, IM Relay1, IM Relay2, U2N Relay] or [IM Relay1, IM Relay2].

After the IM Relay1 402a receives the DCR (or LMR) message from the Remote UE 202, the IM Relay1 402a may send a DCR (or LMR) message to the IM Relay2 402b at 614 which may include information indicating user information associated with the Remote UE 202, user information associated with the U2N Relay UE 204, and path information (e.g., as received at 612). For example, there may be an existing connection between the IM Relay1 402a and the IM Relay2 402b, and the IM Relay1 may send a LMR message to the IM Relay2 402b which may include information indicating user information associated with the Remote UE 202, user information associated with the U2N Relay UE 204, and path information (e.g., as received at 612).

After the IM Relay2 402b receives the DCR (or LMR) message from the IM Relay1 402a at 614, the IM Relay2 402b may send a DCR (or LMR) message to the U2N Relay 204 at 616 which may include information indicating user information associated with the Remote UE 202, user information associated with the U2N Relay UE 204, and path information (e.g., as received at 614). For example, there may be an existing connection between the IM Relay2 402 and the U2N Relay 204, and the IM Relay2 402b may send a LMR message to the U2N Relay 204 which may include information indicating user information associated with the Remote UE 202, user information associated with the U2N Relay UE 204, and path information (e.g., as received at 614).

After receiving the DCR (or LMR) message from the IM Relay2 402b for setting up the connection between the Remote UE 202 and the U2N Relay UE 24 via IM Relay1 402a and IM Relay2 402b, the U2N Relay 204 may detect that the multihop path to the Remote UE 202 has changed at 618. For example, the U2N Relay 204 may check whether there is a valid (e.g., existing) mapping for exchanging traffic of the Remote UE 202. For example, the mapping may include a mapping between packets for the Remote UE 202 to PC5 QoS flows for the connection between the IM Relay3 402c and the U2N Relay 204. The U2N Relay 204 may detect the multihop path to the Remote UE 202 changed to another path, such as from a path including the IM Relay3 402c to another path including the IM Relay2 402b.

At 620, the U2N Relay 204 may send DCA (or LMA) message to the IM Relay2 402b. For example, the DCA (or LMA) message may which include may include information indicating user information associated with the Remote UE 202, user information associated with the U2N Relay UE 204, and path information (e.g., [IM Relay1, IM Relay2]).

After receiving the DCA (or LMA) message at 620, the IM Relay2 402b may send a DCA (or LMA) message to the IM Relay1 402a. For example, the DCA (or LMA) message may include information indicating user information associated with the Remote UE 202, user information associated with the U2N Relay UE 204, and path information (e.g., [IM Relay1, IM Relay2]).

After receiving the DCA (or LMA) message at 622, the IM Relay1 402a may send a DCA (or LMA) message to the Remote UE 202. For example, the DCA (or LMA) message may include information indicating user information associated with the Remote UE 202, user information associated with the U2N Relay UE 204, and path information (e.g., [IM Relay1, IM Relay2]).

After 618 or 620, the U2N Relay 204 may update the mapping of the connection between the U2N Relay 204 and the Remote UE 202 to include the IM Relay2 402b at 626. For example, the U2N Relay 204 may change the path for the Remote UE 202 from [Remote UE, IM Relay1, IM Relay3, U2N Relay] to [Remote UE, IM Relay1, IM Relay2, U2N Relay]) so that the traffic for the Remote UE may be relayed to the proper relay UE (e.g., IM Relay2 402b).

At 628, the U2N Relay 204 may inform the IP address of the Remote UE 202 to the IM Relay2 402b.

At 630, after receiving the IP address for the Remote UE 202, the IM Relay2 402b may update the path between the Remote UE 202 and U2N Relay 204 (e.g., [Remote UE, IM Relay1, IM Relay2, U2N Relay]) to bind with the IP address of Remote UE 202. For example, when receiving an IP packet including the IP address of the Remote UE 202 either as a source IP address or a target IP address, the IM Relay2 402b can determine the destination to relay the IP packet to as IM Relay1 402a (e.g., when receiving an IP packet including the IP address of Remote UE 202 as the target IP address) or as U2N Relay 204 (e.g., when receiving an IP packet including the IP address of Remote UE 202 as the source IP address).

At 632, the IM Relay1 402a may update the connection for the Remote UE 202 to be mapped to the connection with the IM Relay2 402b. For example, the traffic for Remote UE to be relay correctly (e.g., when receiving data from IM Relay2 for Remote UE, it relay it to Remote UE, and when receiving data from Remote UE for U2N relay connection, it relay it to IM Relay2) After receiving the DCA (or LMA) message at 624, the Remote UE 202 may exchange data traffic with the U2N Relay UE 204 via the IM Relay1 402a and the IM Relay2 402b using the IP address assigned from the U2N Relay 204.

In some representative embodiments, the relay reselection procedure (e.g., in FIG. 6) may be triggered by any of the IM Relays 402 (e.g., IM Relay1 402a and/or IM Relay3 402c). For example, when detecting a link failure or link quality degradation between the IM Relay1 402a and the IM Relay3 402c (e.g., due to the mobility of the IM Relay3 402c), the IM Relay1 402a may discover a new path to the U2N Relay 204 (e.g., [IM Relay1, IM Relay2]. In this scenario, the IM Relay1 402a may initiate a DCR (or LMR) message for a new connection setup with the IM Relay2 402b. After, 614 and so forth may proceed as in FIG. 6 with the omission of the IM Relay1 sending a DCA (or LMA) message to the Remote UE 202 at 624. For example, the Remote UE 202 may receive updated path information after the relay reselection is completed between the IM Relay1 402a, IM Relay2 402b, and the U2N Relay 204.

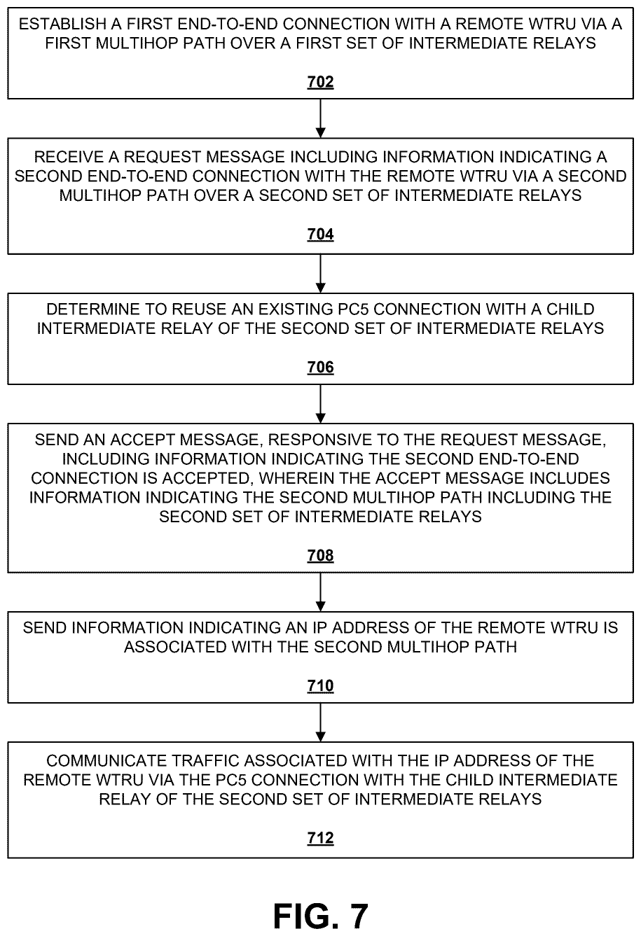

FIG. 7 is a flow diagram illustrating an example procedure which may be implemented by a U2N relay 204 (e.g., WTRU 102 serving as a U2N relay). At 702, the U2N relay 204 may establish a first end-to-end connection with a remote UE 202 (e.g., WTRU 102) via a first multihop path over a first set of IM relays 402 (e.g., WTRUs 102 serving as IM relays) For example, an IP address of the remote UE 202 may be assigned for traffic carried over the first end-to-end connection. At 704, the U2N relay 204 may receive (e.g., from the child IM relay of the second set of IM relays) a request message including (e.g., path) information indicating a second end-to-end connection with the remote UE 202 via a second multihop path (e.g., different than the first multihop path) over a second set (e.g., different than the first set) of IM relays 402. For example, sending of the request message may be triggered due to link failure or link degradation as described herein. At 706, the U2N relay 204 may determine to reuse an existing PC5 connection with a child IM relay of the second set of IM relays 402. At 708, the U2N relay 204 may send (e.g., to the child IM relay of the second set of IM relays) an accept message, responsive to the request message, including information indicating the second end-to-end connection is accepted. For example, the accept message may include (e.g., path) information indicating the second multihop path including the second set of IM relays 402. At 710, the U2N relay 204 may send (e.g., to the child IM relay of the second set of IM relays) information indicating an IP address of the remote UE 202 is associated with the second multihop path. At 712, the U2N relay 204 may communicate (e.g., send and/or receive) traffic associated with the IP address of the remote UE 202 via the PC5 connection with the child IM relay of the second set of IM relays. For example., the traffic may be mapped at the U2N relay 204 so that the traffic is sent over the PC5 connection along the second multihop path to the remote UE 202.

In certain representative embodiments, at least one IM relay of the first multihop path over the first set of IM relays may be different than at least one IM relay of the second multihop path over the second set of IM relays.

In certain representative embodiments, the request message may be a DCR message received via the PC5 connection with the child IM relay of the second set of IM relays.

In certain representative embodiments, the accept message may be a DCA message sent via the PC5 connection with the child IM relay of the second set of IM relays.

In certain representative embodiments, the request message may be a LMR message received via the PC5 connection with the child IM relay of the second set of IM relays.

In certain representative embodiments, the accept message may be a LMA message sent via the PC5 connection with the child IM relay of the second set of IM relays.

In certain representative embodiments, the establishing of the first end-to-end connection with the remote UE 202 via the first multihop path over the first set of IM relays may include sending information indicating (e.g., to the first set of IM relays 402) that the IP address of the remote UE 202 is associated with the first multihop path.

In certain representative embodiments, after the establishing of the first end-to-end connection with the remote UE 202 via the first multihop path over the first set of IM relays at 702 and prior to receiving the request message at 704, the U2N relay 204 may communicate traffic associated with the IP address to the remote UE 202 via the PC5 connection with a child IM relay of the first set of IM relays.

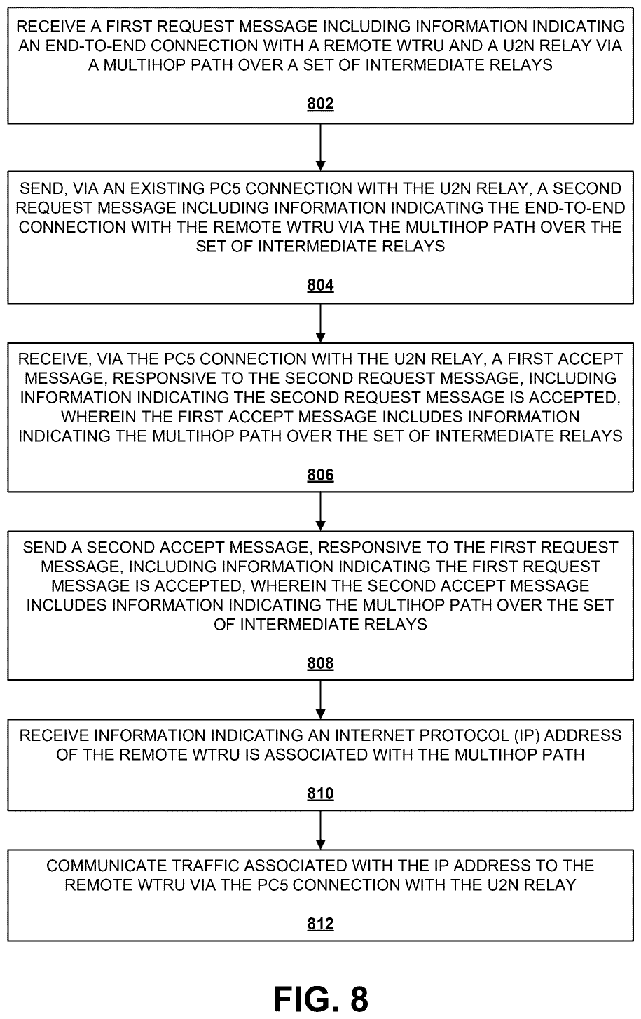

FIG. 8 is a flow diagram illustrating an example procedure which may be implemented by an IM relay 402 (e.g., WTRU 102). At 802, the IM relay 402 may receive a first request message including information indicating an end-to-end connection with a remote UE 202 and a U2N relay 204 (e.g., a WTRU 102 serving as a U2N relay) via a multihop path over a set of IM relays 402 (e.g., including the IM relay 402 itself). For example, the first request message may include (e.g., path) information indicating the multihop path over the set of IM relays. For example, sending of the request message may be triggered due to link failure or link degradation as described herein. At 804, the IM relay 402 may send, via an existing PC5 connection with the U2N relay 204, a second request message including information indicating the end-to-end connection with the remote UE 202 via the multihop path over the set of IM relays. At 806, the IM relay 402 may receive, via the PC5 connection with the U2N relay 204, a first accept message, responsive to the second request message, including information indicating the second request message is accepted. For example, the first accept message may include information indicating the multihop path over the set of IM relays. At 808, the IM relay 402 may send a second accept message, responsive to the first request message, including information indicating the first request message is accepted. For example, the second accept message may include information indicating the multihop path over the set of IM relays. At 810, the IM relay 402 may receive information indicating an IP address of the remote UE 202 is associated with the multihop path. At 812, the IM relay 402 may communicate traffic associated with the IP address to the remote UE 202 via the PC5 connection with the U2N relay.

In certain representative embodiments, the first request message may be a DCR message received from the child IM relay of the set of IM relays 402.

In certain representative embodiments, the second accept message may be a DCA message sent to the child IM relay of the set of IM relays 402.

In certain representative embodiments, the first request message may be a LMR message received via an existing PC5 connection with the child IM relay of the set of IM relays 402.

In certain representative embodiments, the second accept message may be a LMA message sent via the PC5 connection with the child IM relay of the set of IM relays 402.

In certain representative embodiments, the second request message may be a DCR message, and the first accept message may be a DCA message.

In certain representative embodiments, the second request message may be a LMR message, and the first accept message may be a LMA message.

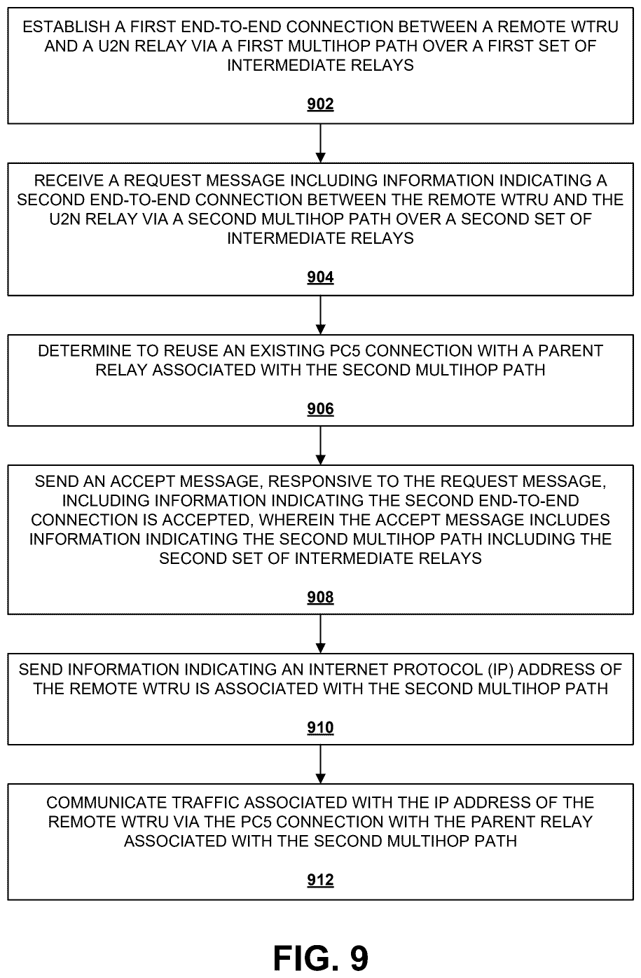

FIG. 9 is a flow diagram illustrating an example procedure which may be implemented by an IM relay 402 (e.g., WTRU 102 serving as an IM relay). At 902, the IM relay 402 may establish a first end-to-end connection between a remote UE 202 (e.g., WTRU 102) and a U2N relay 204 (e.g., another WTRU serving as a U2N relay) via a first multihop path over a first set of IM relays. At 904, the IM relay 402 may receive a request message including information indicating a second end-to-end connection between the remote UE 202 and the U2N relay 204 via a second multihop path over a second set of IM relays 402. For example, the request message may include (e.g., path) information indicating the second multihop path including the second set of IM relays. For example, sending of the request message may be triggered due to link failure or link degradation as described herein. At 906, the IM relay 402 may determine to reuse an existing PC5 connection with a parent relay associated with the second multihop path. At 908, the IM relay 402 may send an accept message, responsive to the request message, including information indicating the second end-to-end connection is accepted. For example, the accept message may include (e.g., path) information indicating the second multihop path including the second set of IM relays. At 910, the IM relay 402 may send (e.g., to a child IM relay of the second set of IM relays) information indicating an IP address of the remote UE 202 is associated with the second multihop path. At 912, the IM relay 402 may communicate traffic associated with the IP address of the remote UE 202 via the PC5 connection with the parent relay associated with the second multihop path.

In certain representative embodiments, the parent relay may be a parent IM relay 402 of the second set of IM relays.

In certain representative embodiments, the parent relay may be the U2N relay 204.

In certain representative embodiments, the request message may be a DCR message received from a child IM relay of the second set of IM relays.

In certain representative embodiments, the accept message may be a DCA message sent to the child IM relay of the second set of IM relays.

In certain representative embodiments, the request message may be a LMR message received from a child IM relay of the second set of IM relays.

In certain representative embodiments, the accept message may be a LMA message sent via the PC5 connection with the child IM relay of the second set of IM relays.

In certain representative embodiments, the establishing of the first end-to-end connection with the remote UE 202 via the first multihop path over the first set of IM relays may include to send information indicating that the IP address of the remote UE 202 is associated with the first multihop path.

In certain representative embodiments, after the establishing of the first end-to-end connection with the remote UE 202 via the first multihop path over the first set of IM relays and prior to receiving the request message, the IM relay 402 may communicate traffic associated with the IP address of the remote UE 202 between a child IM relay of the first set of IM relays and a parent relay.

In certain representative embodiments, after the establishing of the first end-to-end connection with the remote UE 202 via the first multihop path over the first set of IM relays and prior to receiving the request message, the IM relay 402 may communicate traffic associated with the IP address of the remote UE 202 between a child IM relay of the first set of IM relays and a parent relay associated with the first multihop path.

In certain representative embodiments, the communicating of traffic associated with the IP address of the remote UE 202 via the PC5 connection with the parent relay associated with the second multihop path may include (i) sending traffic associated with the IP address of the remote UE 202 received from the parent relay associated with the second multihop path to a child IM relay of the second set of IM relays, and/or (ii) sending traffic associated with the IP address of the remote UE 202 received from the child IM relay to the parent relay associated with the second multihop path.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

What is claimed is:

1. A method implemented by a wireless transmit/receive unit (WTRU) serving as a user equipment-to-network (U2N) relay, the method comprising:
establishing a first end-to-end connection with a remote WTRU via a first multihop path over a first set of intermediate relays;
receiving a request message including information indicating a second end-to-end connection with the remote WTRU via a second multihop path over a second set of intermediate relays;
determining to reuse an existing PC5 connection with a child intermediate relay of the second set of intermediate relays;
sending an accept message, responsive to the request message, including information indicating the second end-to-end connection is accepted, wherein the accept message includes information indicating the second multihop path including the second set of intermediate relays;
sending information indicating an internet protocol (IP) address of the remote WTRU is associated with the second multihop path; and
communicating traffic associated with the IP address of the remote WTRU via the PC5 connection with the child intermediate relay of the second set of intermediate relays.

2. The method of claim 1, wherein at least one intermediate relay of the first multihop path over the first set of intermediate relays is different than at least one intermediate relay of the second multihop path over the second set of intermediate relays.

3. The method of claim 1, wherein the request message is a direct connection request message received via the PC5 connection with the child intermediate relay of the second set of intermediate relays, and the accept message is a direct connection accept message sent via the PC5 connection with the child intermediate relay of the second set of intermediate relays.

4. The method of claim 1, wherein the request message is a link modification request message received via the PC5 connection with the child intermediate relay of the second set of intermediate relays, and the accept message is a link modification accept message sent via the PC5 connection with the child intermediate relay of the second set of intermediate relays.

5. The method of claim 1, wherein the establishing of the first end-to-end connection with the remote WTRU via the first multihop path over the first set of intermediate relays includes sending information indicating the IP address of the remote WTRU is associated with the first multihop path.

6. The method of claim 1, further comprising:
after the establishing of the first end-to-end connection with the remote WTRU via the first multihop path over the first set of intermediate relays and prior to receiving the request message, communicating traffic associated with the IP address to the remote WTRU via the PC5 connection with a child intermediate relay of the first set of intermediate relays.

7. A method implemented by a wireless transmit/receive unit (WTRU) serving as an intermediate relay, the method comprising:
receiving a first request message including information indicating an end-to-end connection with a remote WTRU and a user equipment-to-network (U2N) relay via a multihop path over a set of intermediate relays;
sending, via an existing PC5 connection with the U2N relay, a second request message including information indicating the end-to-end connection with the remote WTRU via the multihop path over the set of intermediate relays;
receiving, via the PC5 connection with the U2N relay, a first accept message, responsive to the second request message, including information indicating the second request message is accepted, wherein the first accept message includes information indicating the multihop path over the set of intermediate relays;
sending a second accept message, responsive to the first request message, including information indicating the first request message is accepted, wherein the second accept message includes information indicating the multihop path over the set of intermediate relays;
receiving information indicating an internet protocol (IP) address of the remote WTRU is associated with the multihop path; and
communicating traffic associated with the IP address to the remote WTRU via the PC5 connection with the U2N relay.

8. The method of claim 7, wherein the first request message is a direct connection request message received from the child intermediate relay of the set of intermediate relays, and the second accept message is a direct connection accept message sent to the child intermediate relay of the set of intermediate relays.

9. The method of claim 7, wherein the first request message is a link modification request message received via an existing PC5 connection with the child intermediate relay of the set of intermediate relays, and the second accept message is a link modification accept message sent via the PC5 connection with the child intermediate relay of the set of intermediate relays.

10. The method of claim 7, wherein the second request message is a direct connection request message, and the first accept message is a direct connection accept message.

11. The method of claim 7, wherein the second request message is a link modification request message, and the first accept message is a link modification accept message.

12. A wireless transmit/receive unit (WTRU) serving as a user equipment-to-network (U2N) relay, comprising:
a processor, memory, and a transceiver which are configured to:
establish a first end-to-end connection with a remote WTRU via a first multihop path over a first set of intermediate relays,
receive a request message including information indicating a second end-to-end connection with the remote WTRU via a second multihop path over a second set of intermediate relays;
determine to reuse an existing PC5 connection with a child intermediate relay of the second set of intermediate relays,
send an accept message, responsive to the request message, including information indicating the second end-to-end connection is accepted, wherein the accept message includes information indicating the second multihop path including the second set of intermediate relays;
send information indicating an internet protocol (IP) address of the remote WTRU is associated with the second multihop path, and
communicate traffic associated with the IP address of the remote WTRU via the PC5 connection with the child intermediate relay of the second set of intermediate relays.

13. The WTRU of claim 12, wherein at least one intermediate relay of the first multihop path over the first set of intermediate relays is different than at least one intermediate relay of the second multihop path over the second set of intermediate relays.

14. The WTRU of claim 12, wherein the request message is a direct connection request message received via the PC5 connection with the child intermediate relay of the second set of intermediate relays, and the accept message is a direct connection accept message sent via the PC5 connection with the child intermediate relay of the second set of intermediate relays.

15. The WTRU of claim 12, wherein the request message is a link modification request message received via the PC5 connection with the child intermediate relay of the second set of intermediate relays, and the accept message is a link modification accept message sent via the PC5 connection with the child intermediate relay of the second set of intermediate relays.

16. The WTRU of claim 12, wherein the establishing of the first end-to-end connection with the remote WTRU via the first multihop path over the first set of intermediate relays includes sending information indicating the IP address of the remote WTRU is associated with the first multihop path.

17. The WTRU of claim 12, wherein the processor, memory, and the transceiver are configured to:
after the establishing of the first end-to-end connection with the remote WTRU via the first multihop path over the first set of intermediate relays and prior to receiving the request message, communicate traffic associated with the IP address to the remote WTRU via the PC5 connection with a child intermediate relay of the first set of intermediate relays.

18. A wireless transmit/receive unit (WTRU) serving as an intermediate relay, comprising:
a processor, memory, and a transceiver configured to:
receive a first request message including information indicating an end-to-end connection with a remote WTRU and a user equipment-to-network (U2N) relay via a multihop path over a set of intermediate relays,
send, via an existing PC5 connection with the U2N relay, a second request message including information indicating the end-to-end connection with the remote WTRU via the multihop path over the set of intermediate relays,
receive, via the PC5 connection with the U2N relay, a first accept message, responsive to the second request message, including information indicating the second request message is accepted, wherein the first accept message includes information indicating the multihop path over the set of intermediate relays,
send a second accept message, responsive to the first request message, including information indicating the first request message is accepted, wherein the second accept message includes information indicating the multihop path over the set of intermediate relays,
receive information indicating an internet protocol (IP) address of the remote WTRU is associated with the multihop path, and
communicate traffic associated with the IP address to the remote WTRU via the PC5 connection with the U2N relay.

19. The WTRU of claim 18, wherein the first request message is a direct connection request message received from the child intermediate relay of the set of intermediate relays, and the second accept message is a direct connection accept message sent to the child intermediate relay of the set of intermediate relays.

20. The WTRU of claim 18, wherein the first request message is a link modification request message received via an existing PC5 connection with the child intermediate relay of the set of intermediate relays, and the second accept message is a link modification accept message sent via the PC5 connection with the child intermediate relay of the set of intermediate relays.

21. The method of claim 18, wherein the second request message is a direct connection request message, and the first accept message is a direct connection accept message.

22. The method of claim 18, wherein the second request message is a link modification request message, and the first accept message is a link modification accept message.

23. A wireless transmit/receive unit (WTRU) serving as an intermediate relay, comprising:
a processor, memory, and a transceiver configured to:
establish a first end-to-end connection between a remote WTRU and a user equipment-to-network (U2N) relay via a first multihop path over a first set of intermediate relays,
receive a request message including information indicating a second end-to-end connection between the remote WTRU and the U2N relay via a second multihop path over a second set of intermediate relays,
determine to reuse an existing PC5 connection with a parent relay associated with the second multihop path,
send an accept message, responsive to the request message, including information indicating the second end-to-end connection is accepted, wherein the accept message includes information indicating the second multihop path including the second set of intermediate relays,
send information indicating an internet protocol (IP) address of the remote WTRU is associated with the second multihop path, and
communicate traffic associated with the IP address of the remote WTRU via the PC5 connection with the parent relay associated with the second multihop path.
